(19) United States
(12) Patent Application Publication
(10) Pub. No.: US 2026/0304365 A1
(43) Pub. Date: Oct. 1, 2026

(54) HANDLING NG-RAN SUBSCRIPTION TO OBTAIN GROUND TRUTH LABEL FOR AI/ML-BASED POSITIONING

(71) Applicants: Centre of Excellence in Wireless Technology, Chennai (IN); Indian Institute of Technology Madras (IIT Madras), Chennai (IN)

(72) Inventors: Jishnu Ponnappan, Chennai (IN); Abhijeet Abhimanyu Masal, Chennai (IN); Anusuya Balasubramanian, Chennai (IN); Aswathy Subramaniam, Chennai (IN); Harini Shree Velmurugan, Chennai (IN); Vikram Krishnakumar, Chennai (IN); Jeniston Deviraj Klutto Milleth, Chennai (IN); Bhaskar Ramamurthi, Chennai (IN)

(21) Appl. No.: 19/577,424

(22) Filed: Mar. 25, 2026

(30) Foreign Application Priority Data
Mar. 25, 2025 (IN) 202541027675
Apr. 25, 2025 (IN) 202541040202

(51) Int. Cl. H04W 64/00; H04L 41/16

(52) U.S. Cl. CPC H04W 64/00; H04L 41/16

(57) ABSTRACT

The present invention discloses a method, an access and mobility management function (AMF) node (200), a location management function (LMF) node (300), and a next-generation radio access network (NG-RAN) (400) for handling NG-RAN (400) subscriptions to obtain ground truth labels (GTL) for AI/ML-based positioning. The method includes receiving, by the AMF node (200), a subscription request from the NG-RAN (400) for obtaining the GTL and deciding, by the AMF node (200), to perform one of accepting, denying, or canceling the subscription request. The method further includes determining and performing, by the AMF node (200), at least one of a proactive method and an opportunistic method to obtain the GTL for the AI/ML-based positioning from at least one LMF node (300) when the subscription request is accepted, and reporting, by the AMF node (200), a failure message to the NG-RAN (400) when the subscription request is denied or canceled.

### FIELD OF INVENTION

The present disclosure pertains to wireless communication systems and, more particularly, to a method and system configured to manage Next-Generation Radio Access Network (NG-RAN) subscription information for the purpose of obtaining ground-truth labeling suitable for Artificial Intelligence (AI) and Machine Learning (ML) based positioning. The application is based on and claims priority from Indian Provisional Applications 20/254,1027675 filed on 25th March 2025 and 202541040202 filed on 25th April 2025, the disclosures of which is hereby incorporated by reference herein.

### BACKGROUND

Positioning has become a foundational capability in Fifth Generation (5G) systems and is expected to remain so in Sixth Generation (6G) networks because numerous commercial and public safety services depend on precise location information. Emergency call positioning, driven by Federal Communications Commission (FCC) mandates, exemplifies the critical nature of accurate and timely location data, yet existing solutions often struggle to meet the mandated accuracy, time-to-first-fix, and latency thresholds. Other mission-critical applications impose even more stringent requirements, further exposing limitations in current positioning approaches.

Ongoing studies within the 3rd Generation Partnership Project (3GPP) have highlighted the potential of augmenting the radio access network (RAN) air interface with artificial intelligence and machine learning (AI/ML) capabilities tailored to specific use cases. However, integrating AI/ML into the air interface introduces challenges involving performance trade-offs, implementation complexity, and impacts on standard specifications. Positioning of user equipment (UE) is one of the targeted features where AI/ML support is being investigated, yet the industry still lacks robust mechanisms to ensure consistent accuracy improvements while maintaining manageable complexity.

Additionally, 3GPP is developing general life cycle management (LCM) procedures for AI/ML functions, including those applied to positioning. Current frameworks do not fully resolve issues related to the deployment, adaptation, and maintenance of AI/ML models in live networks, leaving gaps in reliability and compliance.

Therefore, there is a need to address the aforementioned disadvantages and shortcomings or at least provide a useful alternative.

### OBJECT OF THE INVENTION

The principal object of the invention herein is to provide a method, an access and mobility management function (AMF) node, a location management function (LMF) node, and a next-generation radio access network (NG-RAN) for handling NG-RAN subscription to obtain ground truth labels for AI/ML-based positioning

### SUMMARY

In an aspect the present invention provides a method for handling an NG-RAN subscription to Core Network for obtaining a Ground Truth Label (GTL) for AI/ML-based positioning. The method includes receiving by an AMF node a subscription request from an NG-RAN for obtaining the GTL, where the subscription request message comprises a GTL subscription type, and deciding by the AMF node to perform one of accept, deny, and cancel the subscription request. Further, the method includes determining and performing by the AMF node at least one of the proactive method and the opportunistic method to obtain the GTL for the AI/ML-based positioning from at least one LMF node when the subscription request is accepted, where the at least one of the proactive method and the opportunistic method is indicated in the GTL subscription type, and reporting by the AMF node a failure message to the RAN when the subscription request is one of denied and cancelled.

In another aspect the present invention provides a method for handling an NG-RAN subscription to Core Network for obtaining a GTL for AI/ML-based positioning. The method includes receiving by at least one LMF node a determine location request message for obtaining the GTL, where the determine location request message comprises an instruction indicated by a share location parameter set as one of NG-RAN also’ and NG-RAN only’, initiating by the at least one LMF node positioning procedures for estimating the location of at least one UE, and sending by the at least one LMF node the GTL of the at least one UE to the NG-RAN using a location indication message, wherein the NG-RAN is identified at the LMF node by an NG-RAN Identifier (ID).

In yet another aspect the present invention provides a method for handling an NG-RAN subscription to Core Network for obtaining a GTL for AI/ML-based positioning. The method includes sending by the NG-RAN a subscription request to an AMF node for obtaining GTL, where the subscription request message comprises at least one of a GTL subscription type and at least one UE, and receiving by the NG-RAN the GTL from an LMF node after the AMF node sends a determine location request message to the LMF node.

In yet another aspect the present invention provides an AMF node for handling an NG-RAN subscription to Core Network for obtaining a GTL for AI/ML-based positioning. The AMF node includes a processor, a memory, and a GTL subscription controller connected to the memory and the processor. The GTL subscription controller receives a subscription request from an NG-RAN for obtaining the GTL, where the subscription request message comprises a GTL subscription type, and decides to perform one of accept, deny, and cancel the subscription request. Further, the method includes determining and performing at least one of the proactive method and the opportunistic method to obtain the GTL for the AI/ML-based positioning from at least one LMF node when the subscription request is accepted, where the at least one of the proactive method and the opportunistic method is indicated in the GTL subscription type, and reporting a failure message to the RAN when the subscription request is one of denied and cancelled.

In yet another aspect the present invention provides an LMF node for handling an NG-RAN subscription to Core Network for obtaining a GTL for AI/ML-based positioning. The LMF node includes a processor, a memory, and a positioning session controller connected to the memory and the processor. The positioning session controller receives a determine location request message for obtaining the GTL, where the determine location request message comprises an instruction indicated by a share location parameter set as one of NG-RAN also’ and NG-RAN only’, initiates positioning procedures for estimating the location of at least one UE, and sends the GTL of the at least one UE to the NG-RAN using a location indication message, where the NG-RAN is identified at the LMF node by an NG-RAN ID.

In yet another aspect the present invention provides an NG-RAN for handling an NG-RAN subscription to Core Network for obtaining a GTL for AI/ML-based positioning. The NG-RAN includes a processor, a memory, and an NG-RAN subscription controller connected to the memory and the processor. The NG-RAN subscription controller sends a subscription request to an AMF node for obtaining GTL, where the subscription request message comprises at least one of a GTL subscription type and at least one UE, and receives the GTL from an LMF node after the AMF node sends a determine location request message to the LMF node.

In yet another aspect the present invention provides a method for handling an NG-RAN subscription to Core Network for obtaining a GTL for AI/ML-based positioning. The method includes receiving by an AMF node a subscription request from an NG-RAN for obtaining GTL, where the subscription request message comprises a GTL subscription type, and performing by the AMF node one of sending the subscription of the NG-RAN to at least one LMF node using a data exposure application programming interface (API) and sending the subscription of the NG-RAN to the at least one LMF node and a determine location request for a UE connected to the NG-RAN. Further, the method includes receiving by the AMF node from the at least one LMF a notification related to the subscription request indicating one of accepted, denied, and cancelled, and transmitting by the AMF node a failure indication message to the NG-RAN if the notification is one of denied or cancelled.

In yet another aspect the present invention provides a method for handling an NG-RAN subscription to Core Network for obtaining a GTL for AI/ML-based positioning. The method includes receiving by the at least one LMF node a subscription request of the NG-RAN from the AMF node for the GTL and deciding by the at least one LMF node one of accept, deny, and cancel the subscription request. Further, the method includes sending by the at least one LMF node a notification related to the subscription request indicating one of accepted, denied, and cancelled, and performing by the at least one LMF node at least one of the proactive method and the opportunistic method to send the GTL for the AI/ML-based positioning to the AMF node when the subscription request is accepted.

In yet another aspect the present invention provides an AMF node for handling an NG-RAN subscription to Core Network for obtaining a GTL for AI/ML-based positioning. The AMF node includes a processor, a memory, and a GTL subscription controller connected to the memory and the processor. The GTL subscription controller receives a subscription request from an NG-RAN for obtaining GTL, where the subscription request message comprises a GTL subscription type, and performs one of sending the subscription of the NG-RAN to at least one LMF node using a data exposure API and sending the subscription of the NG-RAN to the at least one LMF node and a determine location request for a UE connected to the NG-RAN. Further, the method includes receiving from the at least one LMF a notification related to the subscription request indicating one of accepted, denied, and cancelled, and transmitting a failure indication message to the NG-RAN if the notification is one of denied or cancelled.

In yet another aspect the present invention provides an LMF node for handling an NG-RAN subscription to Core Network for obtaining a GTL for AI/ML-based positioning. The LMF node includes a processor, a memory, and a positioning session controller connected to the memory and the processor. The positioning session controller receives a subscription request of the NG-RAN from the AMF node for the GTL and decides to perform one of accept, deny, and cancel the subscription request. Further, the method includes sending a notification related to the subscription request indicating one of accepted, denied, and cancelled, and performing at least one of the proactive method and the opportunistic method to send the GTL for the AI/ML-based positioning to the AMF node when the subscription request is accepted.

These and other aspects of the embodiments will be better understood with the following description and accompanying drawings. The descriptions, indicating preferred embodiments and specific details, are for illustration and not limitation. Many changes and modifications may be made within the scope of the embodiments, which include all such modifications.

### BRIEF DESCRIPTION OF FIGURES

The present invention is illustrated in the accompanying drawings, where like reference letters indicate corresponding parts across various figures. The embodiments herein will be better understood from the following description and the accompanying drawings.

FIG. 1 is a schematic diagram that illustrates the functional framework for AI/ML for NR air interface according to prior art

FIG. 2 is a block diagram that illustrates the hardware components associated with the AMF node according to embodiments disclosed herein

FIG. 3 is a block diagram that illustrates the hardware components associated with the LMF node according to embodiments disclosed herein

FIG. 4 is a block diagram that illustrates the hardware components associated with the NG-RAN according to embodiments disclosed herein

FIG. 5 is a flow diagram that illustrates a proposed method for handling an NG-RAN subscription to Core Network for obtaining a GTL for AI/ML-based positioning by the AMF node according to embodiments disclosed herein

FIG. 6 is a flow diagram that illustrates a proposed method for handling an NG-RAN subscription to Core Network for obtaining a GTL for AI/ML-based positioning by the LMF node according to embodiments disclosed herein

FIG. 7 is a flow diagram that illustrates a proposed method for handling an NG-RAN subscription to Core Network for obtaining a GTL for AI/ML-based positioning by the NG-RAN node according to embodiments disclosed herein

FIG. 8 is a flow diagram that illustrates another proposed method for handling an NG-RAN subscription to Core Network for obtaining a GTL for AI/ML-based positioning by the AMF node according to embodiments disclosed herein

FIG. 9 is a flow diagram that illustrates another proposed method for handling an NG-RAN subscription to Core Network for obtaining a GTL for AI/ML-based positioning by the LMF node according to embodiments disclosed herein

FIG. 10 is a schematic diagram that illustrates positioning network architecture for NG-RAN Node-assisted gNB-side model according to embodiments disclosed herein

FIG. 11 is a schematic diagram that illustrates methods of NG-RAN subscription for obtaining GTL from the LMF according to embodiments disclosed herein

FIG. 12 is a schematic diagram that illustrates a method for obtaining GTL of non-served UE according to embodiments disclosed herein

FIG. 13 is a sequence diagram that illustrates a proactive method of AMF-managed NG-RAN subscription for obtaining the ground truth label according to embodiments disclosed herein

FIG. 14 is a sequence diagram that illustrates an opportunistic method of AMF-managed NG-RAN subscription for obtaining the ground truth label according to embodiments disclosed herein

FIG. 15 is a sequence diagram that illustrates a proactive method of LMF-managed NG-RAN subscription for obtaining the ground truth label according to embodiments disclosed herein

FIG. 16 is a sequence diagram that illustrates an opportunistic method of LMF-managed NG-RAN subscription for obtaining the ground truth label according to embodiments disclosed herein

FIG. 17 is a sequence diagram that illustrates a proactive method for obtaining the GTL from the LMF node according to embodiments disclosed herein

### DETAILED DESCRIPTION OF INVENTION

The embodiments and their features are detailed with reference to the non-limiting examples shown in the drawings and described below. Well-known components and techniques are omitted to avoid unnecessary detail. The described embodiments are not mutually exclusive and can be combined to form new embodiments. The term “or” is used in a non-exclusive sense unless stated otherwise. The examples provided are for illustrative purposes to aid understanding and should not be seen as limiting the scope of the embodiments.

As is existing in the field, embodiments can be described and illustrated in terms of blocks which carry out a described function or functions. These blocks, which can be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and can optionally be driven by firmware and software. The circuits may, for example, be embodied in one or more semiconductor chips, or on substrate supports such as printed circuit boards and the like. The circuits constituting a block can be implemented by dedicated hardware, or by a processor (e.g., one or more programmed microprocessors and associated circuitry), or by a combination of dedicated hardware to perform some functions of the block and a processor to perform other functions of the block. Each block of the embodiments can be physically separated into two or more interacting and discrete blocks without departing from the scope of the disclosure. Likewise, the blocks of the embodiments can be physically combined into more complex blocks without departing from the scope of the disclosure.

The drawings help illustrate the technical features but do not limit the embodiments. The disclosure includes any modifications, equivalents, and substitutes beyond those shown. Terms like first, second, etc., are used for distinction and do not limit the elements.

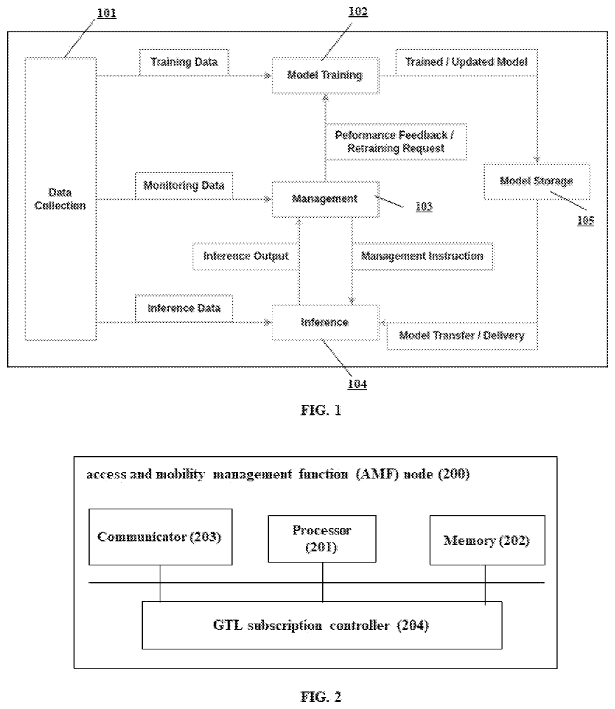

FIG. 1 is a schematic diagram that illustrates the functional framework for AI/ML for an NR air interface according to prior art. Data Collection (101) is a function that provides input data to the functions of Model Training (102), Management (103), and Inference (104). Model Training (102) is a function that performs AI/ML model training, validation, and testing, which may generate model performance metrics that can be used as part of the model testing procedure. The function of Model Training (102) is also responsible for data preparation (e.g., data pre-processing and cleaning, formatting, and transformation) based on Training Data delivered by the function of Data Collection (101), if required. Management (103) is a function that oversees the operation (e.g., selection/(de) activation/switching/fallback) and monitoring (e.g., performance) of AI/ML models or AI/ML functionalities. This function is also responsible for making decisions to ensure the proper inference operation based on data received from the functions of Data Collection (101) and Inference (104). Inference (104) is a function that provides output from the process of applying AI/ML models or AI/ML functionalities using the data that is provided by the function of Data Collection (101) (i.e., Inference Data) as an input. The function of Inference (104) is also responsible for data preparation (e.g., data pre-processing and cleaning, formatting, and transformation) based on data of Inference (104) delivered by the function of Data Collection (101), if required. Model Storage (105) is a function responsible for storing trained/updated models that can be used to perform the function of Inference (104).

Referring now to the drawings, and more particularly to FIGS. 2 through 16, where similar reference characters denote corresponding features consistently throughout the figures, there are shown embodiments.

As illustrated in FIG. 2, the AMF node (200) includes a processor (201), a memory (202), a communicator (203), and a GTL subscription controller (204). The AMF node (200) is a core network control-plane network function configured to manage access and mobility related signaling for user equipment and NG-RAN (400), and to coordinate signaling with one or more other core-network functions for handling subscription procedures associated with obtaining a ground truth location (GTL) for AI/ML-based positioning. In an embodiment, the AMF node (200) is implemented as a network equipment platform comprising at least one hardware processor, at least one memory unit, at least one communication interface, and dedicated control circuitry configured to execute access and mobility management functions. The AMF node (200) may be realized as a rack-mounted server, telecom core-network appliance, blade server, or virtualized network function deployed on underlying physical server hardware.

The GTL subscription controller (204) is implemented as dedicated hardware circuitry operatively coupled to the processor (201), the memory (202), and the communicator (203). In an embodiment, the GTL subscription controller (204) includes one or more cooperating hardware blocks comprising a protocol processing circuit, a subscription control circuit, a policy evaluation circuit, a message generation and routing circuit, and an interface control circuit. These hardware blocks are configured to receive and parse a subscription request associated with obtaining the ground truth location (GTL), determine subscription handling logic, maintain subscription state information, generate and control signaling toward the LMF node (300) and/or the NG-RAN (400), and provide control outputs for execution of GTL subscription procedures. In an embodiment, the GTL subscription controller (204) includes multi-core processing circuitry, wherein respective cores are configured to perform distinct control-plane processing functions associated with subscription handling, signaling coordination, and state management. In an embodiment, the GTL subscription controller (204) further includes dedicated logic circuits, register sets, buffer memory, and interface buses for hardware-level control of subscription processing and signaling exchange. Such structural hardware implementation enables the GTL subscription controller (204) to perform GTL subscription handling as a technical control function within the AMF node (200).

In an embodiment the GTL subscription controller (204) receives a subscription request from the NG-RAN (400) for obtaining the GTL where the subscription request message comprises a GTL subscription type and decides to perform one of accept deny and cancel the subscription request. Upon acceptance the GTL subscription controller (204) determines and performs at least one of the proactive method and the opportunistic method to obtain the GTL for the AI/ML-based positioning from at least one LMF node (300) where the at least one of the proactive method and the opportunistic method is indicated in the GTL subscription type and reports a failure message to the RAN when the subscription request is one of denied and cancelled. Additionally, the GTL subscription controller (204) prepares at least one UE (500) for model training and positioning obtains consents for model training and positioning of the at least one UE (500) and sends a determine location request message to the at least one LMF node (300) where the determine location request message comprises an instruction indicated by a share location parameter set as NG-RAN only. Further the GTL subscription controller (204) receives a NGAP positioning information request message from the NG-RAN (400) where the NG-RAN (400) initiates the training update based on the model monitoring feedback sends a data exposure service request to the LMF node (300) to initiate the positioning session(s) for at least one UE (500) after selecting a suitable LMF node (300) indicates to the LMF node (300) that the subscription is for NG-RAN initiated model training, receives a positioning information report of for at least one UE (500) from the LMF node (300) using data exposure notify service and sends a NGAP positioning information response message to the NG-RAN (400) indicating the GTLs of at least one UE (500) with the corresponding NGAP identities. Furthermore the GTL subscription controller (204) receives a Location Services (LCS) request for the at least one UE (500) from an external client identifies at least one UE (500) associated with the NG-RAN (400) obtains consents for model training and positioning of the at least one UE (500) and sends a determine location request message to the at least one LMF node (300) where the determine location request message comprises an instruction indicated by a share location parameter set as NG-RAN (400) also. In another embodiment the GTL subscription controller (204) receives a subscription request from the NG-RAN (400) for obtaining GTL where the subscription request message comprises a GTL subscription type and performs one of sending the subscription of the NG-RAN (400) to at least one of LMF node (300) using a data exposure application programming interface (API) and sending the subscription of the NG-RAN (400) to the at least one LMF node (300) and a determine location request for a UE (500) connected to the NG-RAN (400). The GTL subscription controller (204) receives from the at least one LMF node (300) a notification related to the subscription request indicating one of accepted denied and cancelled and transmits a failure indication message to the NG-RAN (400) if the notification is one of denied or cancelled. Additionally the GTL subscription controller (204) obtains a consent for the model training and positioning for the at least one UE (500) translates the corresponding NG-AP IDs to the subscriber permanent identifiers (SUPIs) of the at least one UE (500) that provided consent and includes at least one UE (500) from the post-consent set of UEs (500) in the data exposure API to the LMF node (300). Further the GTL subscription controller (204) associates the at least one UE (500) with the at least one LMF node (300) based on the at least one of tracking area and the load utilization.

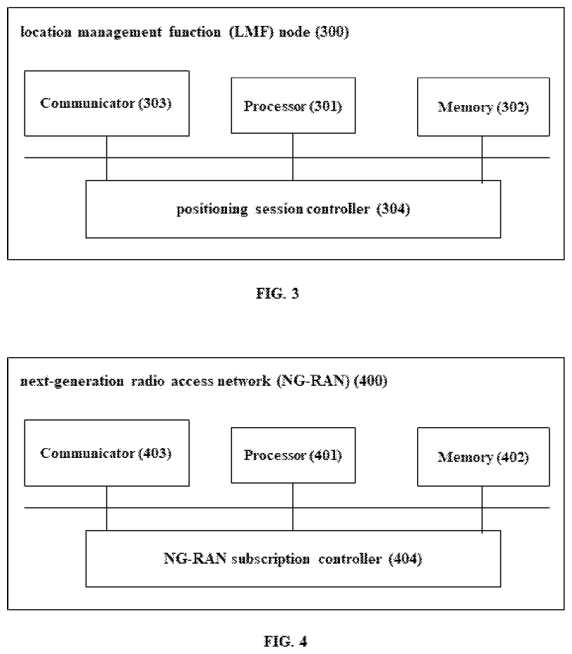

As illustrated in FIG. 3, the LMF node (300) includes a processor (301), a memory (302), a communicator (303), and a positioning session controller (304). The LMF node (300) is a core network positioning function configured to process positioning-related signaling, handle location determination procedures, and coordinate with the AMF node (200) and the NG-RAN (400) for obtaining a ground truth location (GTL) for AI/ML-based positioning. In an embodiment, the LMF node (300) is implemented as a network equipment platform comprising at least one hardware processor, at least one memory unit, at least one communication interface, and dedicated positioning control circuitry configured to execute location management and signaling functions. The LMF node (300) is implemented as a rack-mounted server, telecom core-network appliance, blade server, or virtualized network function deployed on underlying physical server hardware.

The positioning session controller (304) is implemented as dedicated hardware circuitry operatively coupled to the processor (301), the memory (302), and the communicator (303). In an embodiment, the positioning session controller (304) includes one or more cooperating hardware blocks comprising a request processing circuit, a session control circuit, a positioning decision circuit, a message generation and routing circuit, and an interface control circuit. These hardware blocks are configured to receive and parse a determine location request message and a subscription request associated with obtaining the ground truth location (GTL), determine positioning session handling logic, maintain session state information, generate and control signaling toward the AMF node (200) and/or the NG-RAN (400), and provide control outputs for execution of GTL-related positioning procedures. In an embodiment, the positioning session controller (304) includes multi-core processing circuitry, wherein respective cores are configured to perform distinct control-plane processing functions associated with request handling, signaling coordination, session management, and positioning control. In an embodiment, the positioning session controller (304) further includes dedicated logic circuits, register sets, buffer memory, and interface buses for hardware-level control of positioning session processing and signaling exchange. Such structural hardware implementation enables the positioning session controller (304) to perform GTL-related positioning control as a technical control function within the LMF node (300).

In an embodiment the positioning session controller (304) receives a determine location request message for obtaining the GTL where the determine location request message comprises an instruction indicated by a share location parameter set as one of NG-RAN (400) also’ and NG-RAN (400) only’ initiates positioning procedures for estimating the location of at least one UE (500) and sends the GTL of the at least one UE (500) to the NG-RAN (400) using a location indication message where the NG-RAN (400) is identified at the LMF node (300) by a NG-RAN (400) Identifier (ID). Additionally the positioning session controller (304) obtains consent for AI/ML model training for at least one UE (500), consolidates the information related to the location according to the measurement type provided in the service request after the location estimates are computed for at least one UE (500) while the positioning session controller (304) utilizes a location estimate by default when the measurement type is not provided. In an embodiment the positioning session controller (304) receives a subscription request of the NG-RAN (400) from the AMF node (200) for the GTL and decides to perform one of accept deny and cancel the subscription request. Further the positioning session controller (304) sends a notification related to the subscription request indicating one of accepted denied and cancelled and performs at least one of the proactive method and the opportunistic method to send the GTL for the AI/ML-based positioning to the AMF node (200) when the subscription request is accepted. Furthermore, the positioning session controller (304) performs one of requesting at least one UE (500) from the AMF node (200) with consent for model training and positioning and providing the at least one UE (500) to the AMF node (200) when the subscription is accepted. Subsequently the positioning session controller (304) obtains at least one UE (500) with consent for model training and positioning in the area of interest initiates positioning procedures towards at least one UE (500) and sends the GTL to the NG-RAN (400) using a location indication message. Additionally, the positioning session controller (304) finds the at least one UE (500) according to the requirements in the subscription information with the relevant consents for training and positioning using the AMF node (200) when the at least one UE (500) is not provided by the NG-RAN (400). Further the positioning session controller (304) receives a determine location request from the AMF node (200) for at least one UE (500) connected to the RAN with the GTL subscription requests consents of the at least one UE (500) for model training and positioning if not already indicated by the AMF node (200) initiates positioning procedures towards the at least one UE (500) and sends the GTL to the NG-RAN (400) using a location indication message. Further the positioning session controller (304) continues to send the GTL of the at least one UE (500) to the subscribed RAN until the subscription is active or the requirements in the subscription information are met.

As illustrated in FIG. 4, the NG-RAN (400) includes a processor (401), a memory (402), a communicator (403), and a NG-RAN subscription controller (404). The NG-RAN (400) is a radio access network node configured to communicate with the AMF node (200), the LMF node (300), and a user equipment for handling signaling associated with obtaining a ground truth location (GTL) for AI/ML-based positioning. In an embodiment, the NG-RAN (400) is implemented as a radio network equipment platform comprising at least one hardware processor, at least one memory unit, at least one communication interface, and dedicated radio/network control circuitry configured to execute signaling, subscription handling, and positioning-related control functions. The NG-RAN (400) is implemented as a base station, gNB, distributed unit, centralized unit, or virtualized radio access network function deployed on underlying physical hardware.

The processor (401) is configured to execute instructions stored in the memory (402) and perform operations described herein, including handling a NG-RAN subscription to core network for obtaining the GTL for AI/ML-based positioning. The processor (401) is communicatively coupled to the memory (402), the communicator (403), and the NG-RAN subscription controller (404). In an embodiment, the processor (401) includes one or more processing cores such as a CPU and/or an accelerator suitable for protocol processing, policy evaluation, and control-plane workloads.

The memory (402) stores an operating system, platform software, application software, and data used by the processor (401). In an embodiment, the memory (402) comprises one or more non-transitory computer-readable storage media including volatile memory and/or non-volatile memory. In an embodiment, the memory (402) stores the GTL received from the LMF node (300) and subscription-related information associated with positioning procedures.

The communicator (403) is configured to facilitate communication between the AMF node (200), the LMF node (300), and the NG-RAN (400). The communicator (403) supports one or more communication protocols for exchange of control signaling and related data. It ensures that the NG-RAN (400) can communicate effectively with the AMF node (200) and the LMF node (300) for handling the NG-RAN subscription to core network for obtaining the GTL for AI/ML-based positioning. Internal communication between hardware components is also facilitated by the communicator (403). The communicator (403) includes an electronic circuit configured for wired and/or wireless communication. The communicator (403) is configured to receive the GTL from the LMF node (300) and to transmit subscription-related signaling toward the AMF node (200) and/or the LMF node (300).

The NG-RAN subscription controller (404) is implemented as dedicated hardware circuitry operatively coupled to the processor (401), the memory (402), and the communicator (403). In an embodiment, the NG-RAN subscription controller (404) includes one or more cooperating hardware blocks comprising a subscription request processing circuit, a signaling control circuit, a state management circuit, a message generation and routing circuit, and an interface control circuit. These hardware blocks are configured to generate and/or process subscription signaling associated with obtaining the GTL, maintain subscription state information, control signaling exchange with the AMF node (200) and the LMF node (300), and provide control outputs for execution of GTL-related subscription procedures. In an embodiment, the NG-RAN subscription controller (404) includes multi-core processing circuitry, wherein respective cores are configured to perform distinct control-plane processing functions associated with subscription handling, signaling coordination, and state management. In an embodiment, the NG-RAN subscription controller (404) further includes dedicated logic circuits, register sets, buffer memory, and interface buses for hardware-level control of subscription processing and signaling exchange. Such structural hardware implementation enables the NG-RAN subscription controller (404) to perform GTL-related subscription control as a technical control function within the NG-RAN (400).

The NG-RAN subscription controller (404) sends a subscription request to the AMF node (200) for obtaining the GTL, where the subscription request message comprises at least one of a GTL subscription type and at least one UE (500), and receives the GTL from a LMF node (300) after the AMF node (200) sends a determine location request message to the LMF node (300). Additionally, the NG-RAN subscription controller (404) indicates the stop request in a NG-AP model training control message to the AMF node (200) to stop the subscription if it no longer requires the data collection for the AI/ML training and/or performance monitoring. Furthermore, the NG-RAN subscription controller (404) initiates the training update based on the model monitoring feedback and sends a NGAP positioning information request message to the AMF node (200).

FIG. 5 depicts a flow diagram illustrating a proposed method for handling an NG-RAN subscription to a Core Network for obtaining a GTL for AI/ML-based positioning by the AMF node (200) according to embodiments disclosed herein. At step 501, the method includes receiving by the AMF node (200) a subscription request from an NG-RAN (400) for obtaining the GTL, where the subscription request message comprises a GTL subscription type. The subscription request comprises an NGAP model training control message that is a non-UE associated Next Generation Application Protocol (NG-AP) message. The non-UE associated NG-AP message comprises information related to a GTL requirement, where the GTL requirement comprises at least one of optional parameters and an indication to at least one of start, update, and stop the subscription, wherein the optional parameters comprise at least one of the at least one UE (500) preferred by the RAN for training indicated using the NG-AP IDs, a subscription period, a maximum number of GTL data required, an area of interest (AoI), and an indication to one of enable and disable the GTL data from non-serving UEs. At step 502, the method includes deciding by the AMF node (200) to perform one of accept, deny, and cancel the subscription request. At step 503, the method includes determining and performing by the AMF node (200) at least one of the proactive method and the opportunistic method to obtain the GTL for the AI/ML-based positioning from at least one LMF node (300) when the subscription request is accepted, where the at least one of the proactive method and the opportunistic method is indicated in the GTL subscription type. The at least one LMF node (300) is selected based on at least one of a tracking area of the subscribed RAN and a load utilization. Further, the method includes performing by the AMF node (200) the proactive method, which comprises preparing by the AMF node (200) at least one UE (500) for model training and positioning, obtaining by the AMF node (200) consents for model training and positioning of the at least one UE (500), and sending by the AMF node (200) a determine location request message to the at least one LMF node (300), where the determine location request message comprises an instruction indicated by a share location parameter set as “NG-RAN (400) only.” The instruction sends the GTL to the subscribed NG-RAN (400) identified at the LMF node (300) by an NG-RAN (400) Identifier (ID). The at least one UE (500) is one of obtained from the NG-RAN (400) and selected by the AMF node (200). In an embodiment, the method for preparing by the AMF node (200) at least one UE (500) for model training and positioning comprises receiving by the AMF node (200) an NGAP positioning information request message from the NG-RAN (400), where the NG-RAN (400) initiates the training update based on the model monitoring feedback, sending by the AMF node (200) a data exposure service request to the LMF node (300) to initiate the positioning session(s) for at least one UE (500) after selecting a suitable LMF node (300), indicating by the AMF node (200) to the LMF node (300) that the subscription is for NG-RAN initiated model training, receiving by the AMF node (200) a positioning information report of at least one UE (500) in the list from the LMF node (300) using a data exposure notify service, and sending by the AMF node (200) an NGAP positioning information response message to the NG-RAN (400) indicating the GTLs of at least one UE (500) with the corresponding NGAP identities. The NGAP positioning information request message comprise at least one of location information, positioning measurements, and positioning quality of service (QoS). The data exposure service request indicates the parameters provided in the NG-RAN (400) positioning information request message. Furthermore, the method includes performing by the AMF node (200) the opportunistic method, which comprises receiving by the AMF node (200) an LCS request for the at least one UE (500) from an external client, identifying by the AMF node (200) at least one UE (500) associated with the NG-RAN (400), obtaining by the AMF node (200) consents for model training and positioning of the at least one UE (500), and sending by the AMF node (200) a determine location request message to the at least one LMF node (300), where the determine location request message comprises an instruction indicated by a share location parameter set as “NG-RAN (400) also.” The instruction sends the GTL to the NG-RAN (400) identified at the LMF node (300) by an NG-RAN (400) Identifier (ID). At step 504, the method includes reporting by the AMF node (200) a failure message to the RAN when the subscription request is one of denied and cancelled.

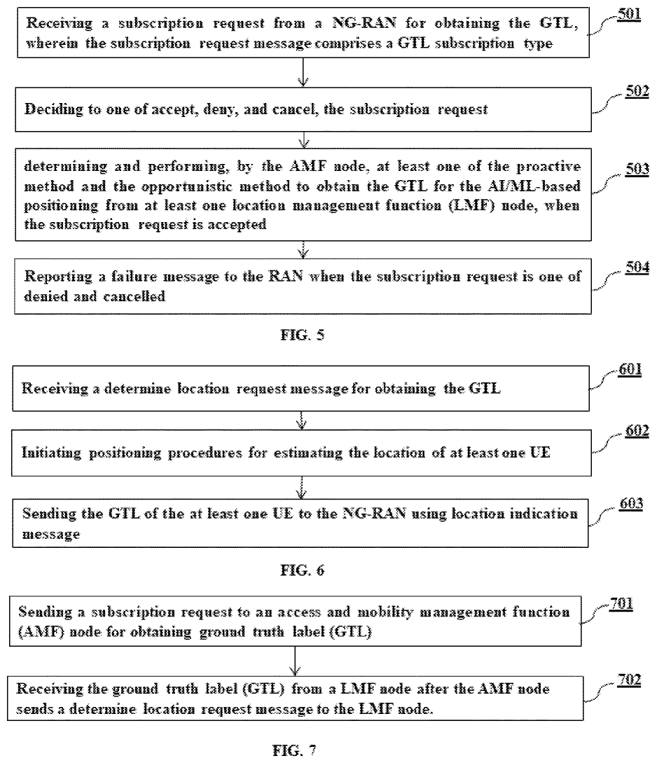

FIG. 6 depicts a flow diagram illustrating a proposed method for handling an NG-RAN subscription to a Core Network for obtaining a GTL for AI/ML-based positioning by the LMF node (300) according to embodiments disclosed herein. At step 601, the method includes receiving by at least one LMF node (300) a determine location request message for obtaining the GTL, where the determine location request message comprises an instruction indicated by a share location parameter set as one of “NG-RAN (400) also” and “NG-RAN (400) only.” At step 602, the method includes initiating by the at least one LMF node (300) positioning procedures for estimating the location of at least one UE (500). In an embodiment, the method for initiation includes obtaining by the LMF node (300) consent for AI/ML model training for at least one of UE (500), consolidating by the LMF node (300) the information related to the location according to the measurement type provided in the service request after the location estimates are computed for the at least one of UE (500). The LMF node (300) utilizes a location estimate by default when the measurement type is not provided. The measurement type comprises at least one of location information, positioning measurements, and positioning quality of service (QoS). At step 603, the method includes sending by the at least one LMF node (300) the GTL of the at least one UE (500) to the NG-RAN (400) using a location indication message, where the NG-RAN (400) is identified at the LMF node (300) by an NG-RAN (400) Identifier (ID). The location indication message is sent using one of a new radio positioning protocol annex (NRPPa) and an LTE positioning protocol (LPPa). The GTL is at least one of a location of at least one UE (500), a gNB ID, a LoS/NLoS information, a time stamp, a quality information, and a gNB Rx-Tx time difference. Further, the method includes sending the GTL of the at least one UE (500) until one of the subscription is active and the requirements in subscription information are met.

FIG. 7 depicts a flow diagram illustrating a proposed method for handling an NG-RAN subscription to a Core Network for obtaining a GTL for AI/ML-based positioning by the NG-RAN (400) according to embodiments disclosed herein. At step 701, the method includes sending by the NG-RAN (400) a subscription request to the AMF node (200) for obtaining a ground truth label (GTL), where the subscription request message comprises at least one of a GTL subscription type and at least one UE (500). The subscription request comprises an NGAP model training control message that is a non-UE associated Next Generation Application Protocol (NGAP) message. The non-UE associated NG-AP message comprises information related to a GTL requirement, where the GTL requirement comprises at least one of optional parameters and an indication to at least one of start, update, and stop the subscription, and where the optional parameters comprise at least one of the list of UEs (500) preferred by the NG-RAN (400) for training indicated using the NG-AP IDs, a subscription period for which the GTL is required, a maximum number of GTL data required, an area of interest (AoI) for the NG-RAN (400) to train the AI/ML model, and an indication to enable or disable the GTL data from non-serving UEs. In an embodiment, the method for sending the subscription request to the AMF node (200) for obtaining a ground truth label (GTL) comprises initiating by the NG-RAN (400) the training update based on the model monitoring feedback and sending by the NG-RAN (400) an NGAP positioning information request message to the AMF node (200). The NGAP positioning information request message indicates at least one of the requirement for the GTL from the LMF node (300), the list of suitable UE(s), and the measurement type comprising location information, positioning measurements, and positioning quality of service (QoS). At step 702, the method includes receiving by the NG-RAN (400) the GTL from the LMF node (300) after the AMF node (200) sends a determine location request message to the LMF node (300). Further, the method includes indicating by the NG-RAN (400) the stop request in an NG-AP model training control message to the AMF node (200) to stop the subscription if it no longer requires the data collection for the AI/ML training and/or performance monitoring.

FIG. 8 depicts a flow diagram illustrating another proposed method for handling an NG-RAN subscription to a Core Network for obtaining a GTL for AI/ML-based positioning by the AMF node (200) according to embodiments disclosed herein. At step 801, the method includes receiving by the AMF node (200) a subscription request from an NG-RAN (400) for obtaining a ground truth label (GTL), where the subscription request message comprises a GTL subscription type. The subscription request comprises an NGAP model training control message that is a non-UE-associated Next Generation Application Protocol (NGAP) message. The non-UE-associated NGAP message comprises the information related to the GTL requirement, where the GTL requirement comprises at least one of optional parameters and an indication to at least one of start and stop the subscription, and where the optional parameters comprise at least one of at least one UE (500) preferred by the NG-RAN (400) for training indicated using the NGAP IDs, a subscription period for which the GTL is required, a maximum number of GTL data required, an area of interest (AoI) for the NG-RAN (400) to train the AI/ML model, and an indication to enable or disable the GTL data from non-serving UEs. Further, the method includes obtaining by the AMF node (200) a consent for the model training and positioning for the at least one UE (500), translating by the AMF node (200) the corresponding NGAP IDs to the subscriber permanent identifiers (SUPIs) of the at least one UE (500) that provided consent, and including by the AMF node (200) at least one UE (500) from the post-consent set of UEs (500) in the data exposure API to the LMF node (300).

At step 802, the method includes performing by the AMF node (200) one of sending the subscription of the NG-RAN (400) to at least one LMF node (300) using a data exposure application programming interface (API) and sending the subscription of the NG-RAN (400) to the at least one LMF node (300) and a determine location request for a UE (500) connected to the NG-RAN (400). The determine location request is sent after receiving an LCS request from a client for the UE (500). The at least one LMF node (300) is selected based on at least one of the tracking area of the NG-RAN (400) and the load utilization.

At step 803, the method includes receiving by the AMF node (200) from the at least one LMF node (300) a notification related to the subscription request indicating one of accepted, denied, and cancelled. At step 804, the method includes transmitting by the AMF node (200) a failure indication message to the NG-RAN (400) if the notification is one of denied or cancelled. Further, the method includes associating by the AMF node (200) the at least one UE (500) with the at least one LMF node (300) based on at least one of the tracking area and the load utilization.

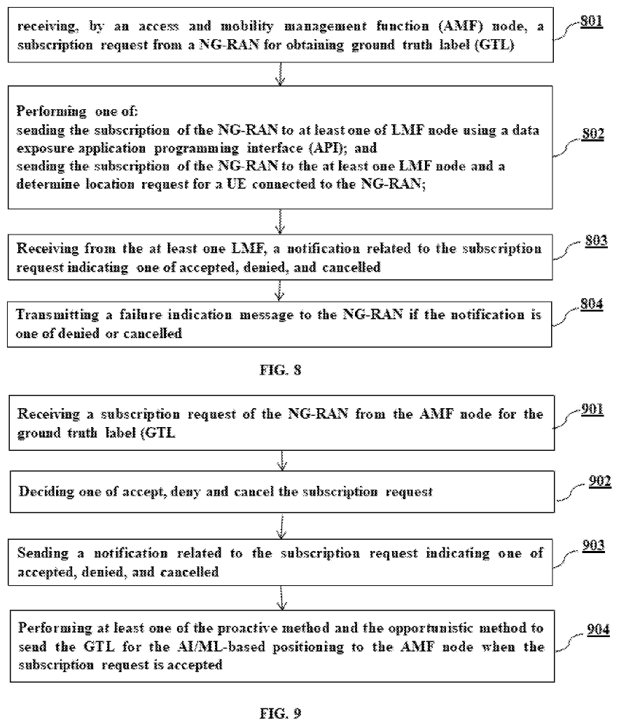

FIG. 9 depicts a flow diagram illustrating another proposed method for handling an NG-RAN subscription to a Core Network for obtaining a GTL for AI/ML-based positioning by the LMF node (300) according to embodiments disclosed herein. At step 901, the method includes receiving by the at least one LMF node (300) a subscription request of the NG-RAN (400) from the AMF node (200) for the GTL. The subscription request of the NG-RAN (400) is received using at least one of the data exposure application programming interface (API) or determine location request.

At step 902, the method includes deciding by the at least one LMF node (300) to perform one of accept, deny, and cancel the subscription request. At step 903, the method includes sending by the at least one LMF node (300) a notification related to the subscription request indicating one of accepted, denied, and cancelled. At step 904, the method includes performing by the at least one LMF node (300) at least one of the proactive method and the opportunistic method to send the GTL for the AI/ML-based positioning to the AMF node (200) when the subscription request is accepted. Further, the method includes performing by the LMF node (300) the proactive method comprising performing one of requesting by the at least one LMF node (300) at least one UE (500) from the AMF node (200) with consent for model training and positioning and providing the at least one UE (500) to the AMF node (200) when the subscription is accepted. Furthermore, the method includes obtaining by the at least one LMF node (300) at least one UE (500) with consent for model training and positioning in the area of interest, initiating by the at least one LMF node (300) positioning procedures towards at least one UE (500), and sending by the at least one LMF node (300) the GTL to the NG-RAN (400) using a location indication message. The location indication message is sent using one of a new radio positioning protocol annex (NRPPa) and LTE positioning protocol annex (LPPa). The GTL is at least one of location of at least one UE (500), a gNB ID, a LoS/NLoS information, a time stamp, a quality information, and gNB Rx-Tx time difference. The LMF node (300) finds the at least one UE (500) according to the requirements in the subscription information with the relevant consents for training and positioning using the AMF node (200) when the at least one UE (500) is not provided by the NG-RAN (400).

Furthermore, the method includes performing by the LMF node (300) the opportunistic method comprising receiving by the at least one LMF node (300) a determine location request from the AMF node (200) for at least one UE (500) connected to the RAN with the GTL subscription, requesting by the at least one LMF node (300) consents of the at least one UE (500) for model training and positioning if not already indicated by the AMF node (200), initiating by the at least one LMF node (300) positioning procedures towards the at least one UE (500), and sending by the at least one LMF node (300) the GTL to the NG-RAN (400) using a location indication message. The location indication message is sent using one of a new radio positioning protocol annex (NRPPa) and LTE positioning protocol annex (LPPa). The GTL is at least one of location of at least one UE (500), a gNB ID, a LoS/NLoS information, a time stamp, a quality information, and gNB Rx-Tx time difference. The at least one LMF node (300) continues to send the GTL of the at least one UE (500) to the subscribed RAN until the subscription is active or the requirements in the subscription information are met.

The application of AI/ML in positioning along with accuracy enhancement is divided into two categories including direct AI/ML positioning and AI/ML-assisted positioning. In the direct AI/ML positioning, the output of the AI/ML model is the location of the UE (500), for example fingerprinting based on channel observation as the input of the AI/ML model. In the case of the AI/ML-assisted positioning, the output of the AI/ML model is a new measurement and/or enhancement of the existing measurement, where line of sight (LoS)/non-line of sight (NLoS) identification, timing and/or angle of measurement, and likelihood of measurement are some of the examples.

The AI/ML model(s) may be located either at the UE-side, or at the LMF-side, or at the gNB-side. Similarly, the positioning computation is performed either as UE-based, gNB-based, or LMF-based. The LMF-based computation is either UE-assisted or next generation random access network (NsG-RAN) node-assisted. Based on the above criteria, the positioning enhancement use cases are illustrated in the Table I below:

TABLE I

| | | AI/ML | AI/ML | Positioning |
|---|---|---|---|---|
| | Positioning | Inference | Positioning | Methods |
| Case | Computation | Location | Type | Supported |
| 1 | UE-based | UE-side | Direct | AI/ML Methods |
| 2a | UE-assisted/ | UE-side | Assisted | DL-TDOA, DL- |
| | LMF-based | | | AoD, Multi-RTT, |
| | | | | NR E-CID |
| 2b | UE-assisted/ | LMF-side | Direct | AI/ML Methods |
| | LMF-based | | | |
| 3a | NG-RAN | gNB-side | Assisted | Multi-RTT, NR E- |
| | node assisted | | | CID, UL-TDOA, |
| | | | | UL-AoA |
| 3b | NG-RAN | LMF-side | Direct | AI/ML Methods |
| | node assisted | | | |

As illustrated in Table I, the inference location for the direct AI/ML approach can be either UE-sided or LMF-sided. The positioning computation is UE-based for the UE-sided inference, whereas the positioning computation is UE-assisted for the LMF-sided inference or NG-RAN-assisted, which can be called LMF-based. Similarly, the inference location can be at the UE (500) side, the LMF side, or the gNB side for the AI/ML-assisted approach. The positioning computation is UE-assisted/LMF-based for UE-sided inference, while the positioning computation is NG-RAN node-assisted for the gNB-sided inference. The positioning computation can be either UE-assisted/LMF-based or NG-RAN node-assisted for the LMF-sided inference.

The proposed solution provides the details on the case 3a where NG-RAN-based AI/ML model is used to infer the positioning measurements like time of arrival (ToA), angle of arrival (AoA), etc. The measurements are then forwarded to the LMF for estimation of location of the UE (500).

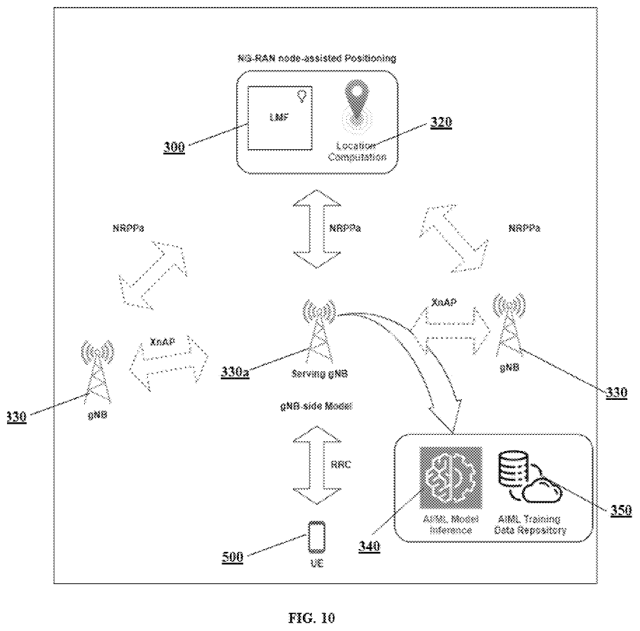

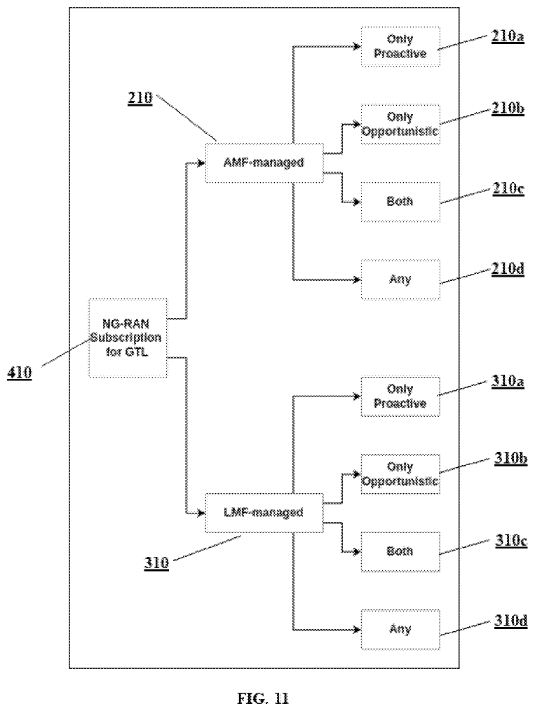

FIG. 10 schematically illustrates positioning network architecture for the NG-RAN (400) Node-assisted gNB-side model according to embodiments disclosed herein. In an embodiment, the AI/ML positioning for case 3a as illustrated in FIG. 10 is classified as an AI/ML-assisted positioning method where the AI/ML inference at the serving gNB (330a) predicts the positioning measurements such as ToA, angle of arrival (AoA), carrier phase, etc. These measurements are provided to the LMF node (300) for positioning location computation (320) of the UE (500). The training, monitoring, and storage aspects of the gNB-side model are handled at the gNB or the operations and management entity (OAM) associated with the gNB using the AI/ML model inference (340) and the AI/ML training data repository (350). For the inference phase, the existing new radio positioning protocol (NRPPa) signaling is sufficient to perform the AI/ML-assisted positioning. However, for training the AI/ML model, there are some modifications/additions required from the signaling perspective which are provided in the following embodiments.

FIG. 11 schematically illustrates NG-RAN subscription for obtaining GTL methods (410) from the LMF node (300) according to embodiments disclosed herein. In an embodiment, for training supervised AI/ML models there is a need for the GTL which sets the benchmark for calibrating the model accurately. Further, this label may be used for model monitoring purposes as well. In the case of AI/ML positioning, this label is the location information (absolute/relative) and is provided by the LMF node (300). Hence, for the gNB-side model the gNB (330) must obtain the GTL from the LMF node (300) before the start of data collection and model training procedures. The solution proposes some of the possible methods by which the gNB (330) can subscribe to the core network for obtaining the GTL from the LMF node (300) as illustrated in the figure.

In an embodiment, the NG-RAN (400) subscribes for the GTL to the core network (CN) using a non-UE associated next generation access protocol (NG-AP) model training control message. The GTL subscription can be handled using two methods, AMF-managed subscription (210) and LMF-managed subscription (310). The NG-RAN (400) is unaware of the entity managing the subscription. Hence, the subscription information provided by the NG-RAN (400) in the NG-AP model training control message is the same for both the methods. The subscription information can have the following parameters: an indication to start/update/stop the GTL subscription, an indication to specify the GTL subscription type like one of the proactive or opportunistic methods decided by the CN or at least one of proactive method and opportunistic methods, optional parameters such as a list of UE(s) preferred by the NG-RAN (400) for training indicated using the NG-AP ID(s), a subscription period for which the GTL is required, maximum number of GTL data required, area of interest (AoI) for the NG-RAN (400) to train the AI/ML model, an indication to enable/disable GTL data from non-serving UE(s), etc.

In an embodiment, in the AMF-managed subscription method using the proactive approach (210a), the AMF node (200) gets the subscription request from the NG-RAN (400) over the non-UE associated NG-AP model training control message and based on the subscription information prepares the list of UE(s) (500) associated with the NG-RAN (400) with all the relevant consents for model training and positioning, selects one or more LMF nodes (300) if required, and assigns the location computation task for each of the UE(s) to the appropriate LMF node(s) (300). The LMF node(s) (300) is (are) instructed by a share location parameter set as “NG-RAN (400) only” to send the estimated location (GTL) of each of the UE(s) (500) to the NG-RAN (400) over the NRPPa message at the end of the corresponding positioning session. The LMF node(s) (300) initiate(s) the positioning session based on a legacy positioning method and once the estimated location is computed the LMF node(s) (300) send(s) the estimated location of each of the UE(s) (500) to the NG-RAN (400).

In an embodiment, in the AMF-managed subscription method using the opportunistic approach (210b), whenever any request from a client for the location services (LCS) of any target UE (510) associated with the subscribed NG-RAN (400) is received at the AMF node (200), the AMF node (200) initiates the conventional procedure of selecting a suitable LMF node (300) and sends a determine location request to the LMF node (300). The AMF node (200) in addition adds an instruction indicated by a share location parameter set as “NG-RAN (400) also” to the LMF node (300) for sending the estimated location of the respective target UE (510) to the subscribed NG-RAN (400) as well as the LCS client upon completion of the location computation. The legacy positioning procedures occur as per the norms with the addition of location sharing to the NG-RAN (400) by the LMF node (300).

In an embodiment, in the LMF-managed subscription (310), upon receiving the subscription request from the NG-RAN (400) the AMF node (200) selects one or more LMF nodes (300) if required and forwards the NG-RAN (400) subscription information to the LMF node(s) (300). The LMF node(s) (300) handle(s) the subscription. In the LMF-managed proactive approach (310a), the LMF node(s) (300) obtain(s) the list of UE(s) (500) associated with the NG-RAN (400) from the AMF node (200). The LMF node(s) (300) also obtain(s) all the relevant consents for model training and positioning. The LMF(s) initiate(s) the positioning session based on a legacy positioning method. The LMF node (300) assigns a notification correlation identifier for each UE (500). The notification correlation identifier is sent to the AMF node (200) to map each UE's (500) positioning session. The AMF node (200) can fetch the details of the UE (500) based on the correlation identifier during the positioning session. Upon completing the location computation, the LMF node(s) (300) send(s) the estimated location of each of the UE(s) (500) to the NG-RAN (400). In the LMF-managed opportunistic approach (310b), if the LMF node (300) selected for localization is handling the NG-RAN (400) subscription and whenever a LCS request for any UE (500) associated with the subscribed NG-RAN (400) is received at the LMF node (300), the LMF node (300) sends the estimated location to the subscribed NG-RAN (400) upon completing the location computation.

In an embodiment, for both (210c and 310c) the AMF-managed and the LMF-managed subscription methods, if the subscription information from the NG-RAN (400) provides a list of UE(s) (500) preferred by the NG-RAN (400) for training indicated using the NG-AP ID(s), the AMF node (200) translates the NG-AP IDs to the corresponding subscription permanent identifier (SUPI) and indicates to the LMF node (300) along with the determine location request so that the selected LMF node(s) (300) is (are) able to identify the UE(s) (500).

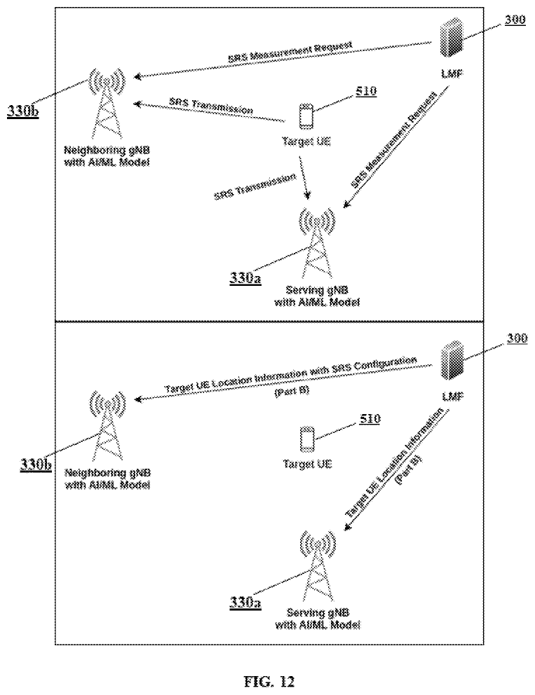

FIG. 12 is a schematic diagram that illustrates a method for obtaining GTL of a non-served UE according to embodiments disclosed herein. In an embodiment, the LMF-managed subscription method (310) provides an additional benefit in terms of diversity in training the AI/ML model by allowing the subscribed NG-RAN (400) to access the GTL of non-serving UE(s). For an LCS request received at the LMF node (300) for any target UE (505), when the LMF node (300) identifies that the subscribed NG-RAN (400) is part of the positioning method in the localization of the target UE (510) as an assisting neighboring gNB (330b), the LMF node (300) sends the location of the target UE (510) to the subscribed NG-RAN (400) along with the corresponding sounding reference signal (SRS) configuration. The signaling overview for obtaining the GTL of the non-serving UE is illustrated in the figure.

As depicted in FIG. 12, an ongoing positioning procedure using any uplink positioning method is assumed with the serving gNB (330a) and the neighboring gNB (330b) having the AI/ML models supporting case 3a and both being subscribed for GTL from the network. The initial positioning procedural steps are performed as per the norms. The LMF node (300) requests the gNBs (330) involved for the SRS reception from the target UE (510) using the corresponding SRS configurations. The gNBs (330) receive the SRS transmission from the target UE (510), which can be processed to derive Part A for training the respective AI/ML models either before obtaining Part B or after obtaining Part B. The SRS measurement reports from the gNBs are sent to the LMF node (300), where the positioning algorithm estimates the location of the target UE (510) based on the measurement report information. The GTL is considered as Part B for training the AI/ML models, and for the AI/ML positioning use case, the GTL is the location information. Because the gNBs (330) are subscribed to the GTL, the LMF node (300) sends the target UE location information to the serving gNB (330a) and the neighboring gNB (330b). The serving gNB (330a) can map Part B information with Part A since the target UE (510) is connected to it. The neighboring gNB (330b) cannot identify the target UE (510) only with Part B since the target UE (510) is a non-serving UE for the neighboring gNB (330b). Therefore, for mapping Part B information with Part A at the neighboring gNB (330b), the LMF node (300) sends the SRS configuration used to obtain Part A along with Part B information to the neighboring gNB (330b). The neighboring gNB (330b) uses the SRS configuration to map Part A and Part B information to train its AI/ML model.

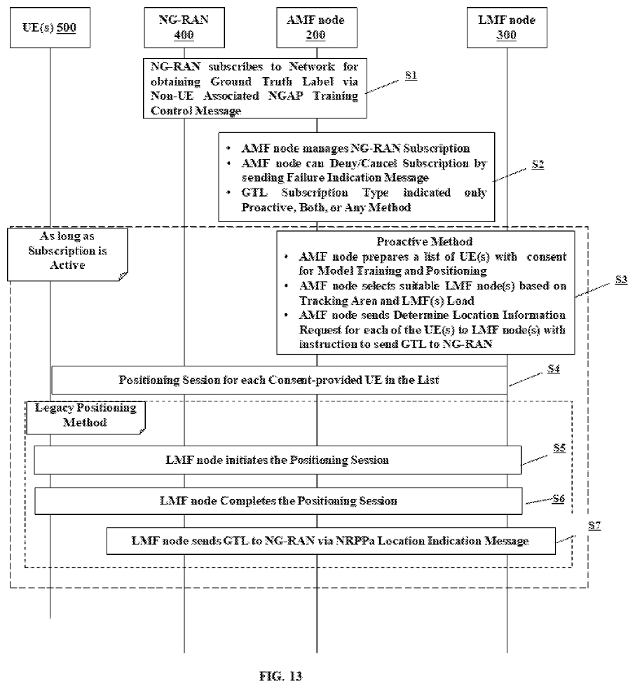

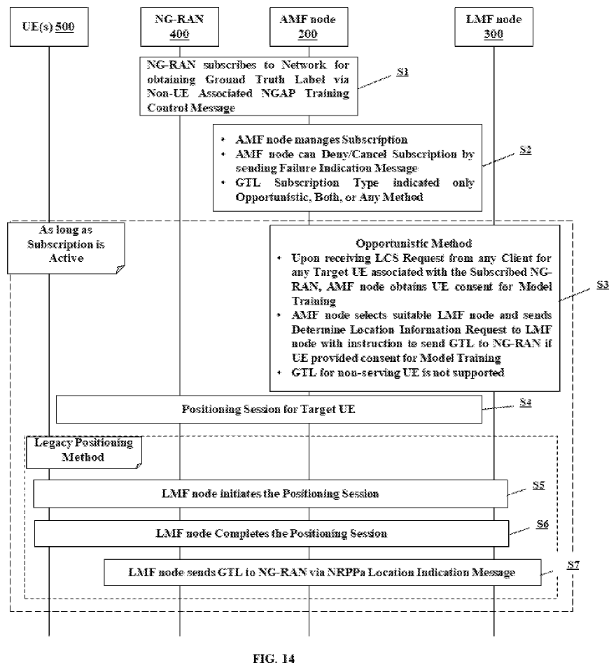

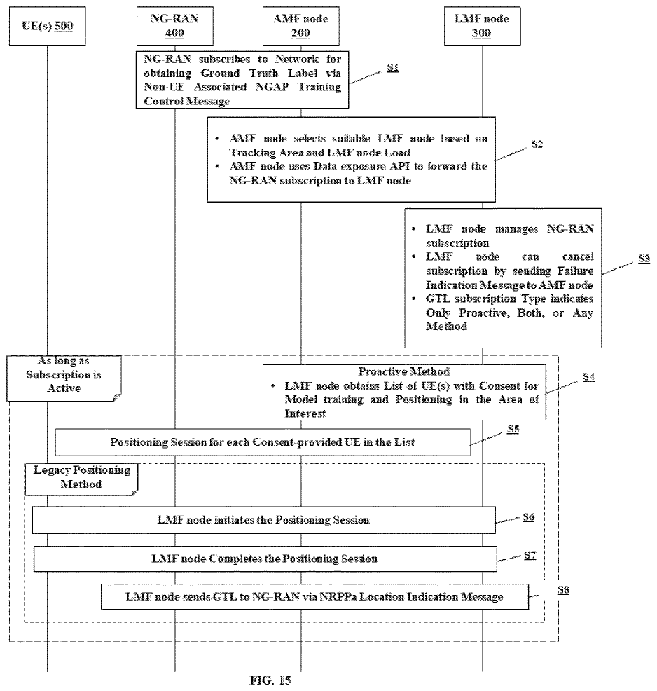

FIG. 13 is a sequence diagram that illustrates a proactive method of AMF-managed NG-RAN subscription for obtaining the GTL according to embodiments disclosed herein, and FIG. 14 is a sequence diagram that illustrates an opportunistic method of AMF-managed NG-RAN subscription for obtaining the GTL according to embodiments disclosed herein. In an embodiment, FIGS. 13-14 depict the signaling mechanism for the AMF-managed NG-RAN (400) subscription method to get the GTL. At step S1, the NG-RAN (400) subscribes to the network for obtaining the GTL using a new non-UE associated NG-AP message, viz., NGAP model training control message. This message acts as the subscription request from the NG-RAN (400) to the network and is oblivious to the subscription managing entity. This message carries the information related to the GTL requirement such as indication to start/update/stop the subscription and optional parameters such as the list of UE(s) (500) preferred by the NG-RAN (400) for training indicated using the NG-AP IDs, the subscription period for which the GTL is required, the maximum number of GTL data required, area of interest (AoI) for the NG-RAN (400) to train the AI/ML model, an indication to enable/disable GTL data from non-serving UE(s), etc. In an embodiment, at step S2, the AMF node (200) manages the subscription request of the NG-RAN (400) by accepting, denying, or cancelling it. If the AMF node (200) accepts the subscription, it prepares a list of the UE(s) (500) when the subscription type indicates only proactive, both, or any method as depicted in FIG. 13. At step S3, when the list is provided by the NG-RAN (400), the AMF node (200) obtains the consents for model training and positioning from the UE(s) (500) in the list. If the list is not provided by the NG-RAN (400), the AMF node (200) finds a list of UE(s) (500) according to the requirements in the subscription information with the relevant consents for training and positioning. The AMF node (200) then proceeds to discover and select one or more suitable LMF nodes (300) based on the tracking area of the subscribed NG-RAN (400) and the load utilization of the LMF node(s) (300). For each of the UE(s) (500) in the list, the AMF node (200) sends a determine location request message to the appropriate LMF node(s) (300) with an additional instruction indicated by the share location parameter set as “NG-RAN (400) only” to send the location estimation result to the subscribed NG-RAN (400) identified at the LMF node (300) by the gNB ID. At step S4, the positioning session for each consent-provided UE in the list is initiated. At step S5, the LMF node(s) (300) initiate the legacy positioning procedures as per the norms for each of the UE(s) (500) assigned for location estimation at the LMF node(s) (300), and once the location estimation is completed at step S6, the LMF node(s) (300) send the corresponding UE (500) location to the subscribed NG-RAN (400) using a new radio positioning protocol annex (NRPPa) location indication message at step S7. This process continues until the subscription is active or the requirements in the subscription information are met. The subscription can also be cancelled by the AMF node (200) by sending an NGAP failure indication message to the NG-RAN (400). The NG-RAN (400) can update the subscription information if required by indicating the update request in the NG-AP model training control message to the AMF node (200) with the updated parameters. The NG-RAN (400) can also stop the subscription if it no longer requires the data collection for the AI/ML training and/or performance monitoring by indicating the stop request in the NG-AP model training control message to the AMF node (200).

FIG. 14 illustrates a sequence diagram depicting an opportunistic method of AMF-managed NG-RAN subscription for obtaining the GTL according to embodiments disclosed herein. At step S1, the NG-RAN (400) subscribes to the network for obtaining the GTL using a new non-UE-associated NG-AP message, viz., an NGAP model training control message. This message acts as the subscription request from the NG-RAN (400) to the network and remains oblivious to the subscription managing entity. The message carries information related to the GTL requirement, such as an indication to start/update/stop the subscription, and optional parameters such as the list of UE(s) (500) preferred by the NG-RAN (400) for training indicated using the NG-AP IDs, the subscription period for which the GTL is required, the maximum number of GTL data required, the area of interest (AoI) for the NG-RAN (400) to train the AI/ML model, and an indication to enable/disable GTL data from non-serving UE(s), etc. At step S2, the AMF node (200) manages the subscription request of the NG-RAN (400) by accepting, denying, or cancelling it. If the AMF node (200) accepts the subscription, it prepares a list of the UE(s) (500) when the subscription type indicates only proactive, both, or any method as depicted in FIG. 14. In an embodiment, the AMF node (200) can use the opportunistic method by taking advantage of any positioning request invoked by any client for any UE (500) associated with the subscribed NG-RAN (400) if the GTL subscription type indicates only opportunistic, both, or any methods as depicted in FIG. 14. At step S3, when the AMF node (200) receives an LCS request for a UE (500) connected to the NG-RAN (400) with subscription, the AMF node (200) requests the consent of the UE (500) for model training and, if the consent is provided, the AMF node (200) proceeds with the discovery and selection of a suitable LMF node (300). The conventional positioning request for the UE (500) is triggered to the LMF node (300) with an additional instruction indicated by the share location parameter set as “NG-RAN (400) also” to send the location estimate of the UE (500) to the subscribed NG-RAN (400) identified by the gNB ID at the LMF node (200) as well as the LCS client. The AMF-managed NG-RAN (400) subscription cannot support obtaining the GTL data of a non-serving UE for the subscribed NG-RAN (400). The subscribed NG-RAN (400) can only get Part A and Part B of the non-serving UE if it participates in the positioning session for the non-serving UE as an assisting neighboring gNB (330b). However, there is no mechanism for the AMF node (200) to identify the participating gNBs in a positioning session other than the serving gNB (330a). Any new signalling to enable this identification involves significant overheads at the AMF node (200) and thereby outweighs the benefit from using the non-serving UE(s) for the model training and/or performance monitoring. At step S4, the positioning session for the target UE is initiated. At step S5, the LMF node(s) (300) initiate(s) the legacy positioning procedures as per the norms for each of the UE (500) assigned for location estimation at the LMF node(s) (300), and once the location estimation is completed at step S6, the LMF node(s) (300) send(s) the corresponding UE (500) location to the subscribed NG-RAN (400) using a new radio positioning protocol annex (NRPPa) location indication message at step S7.

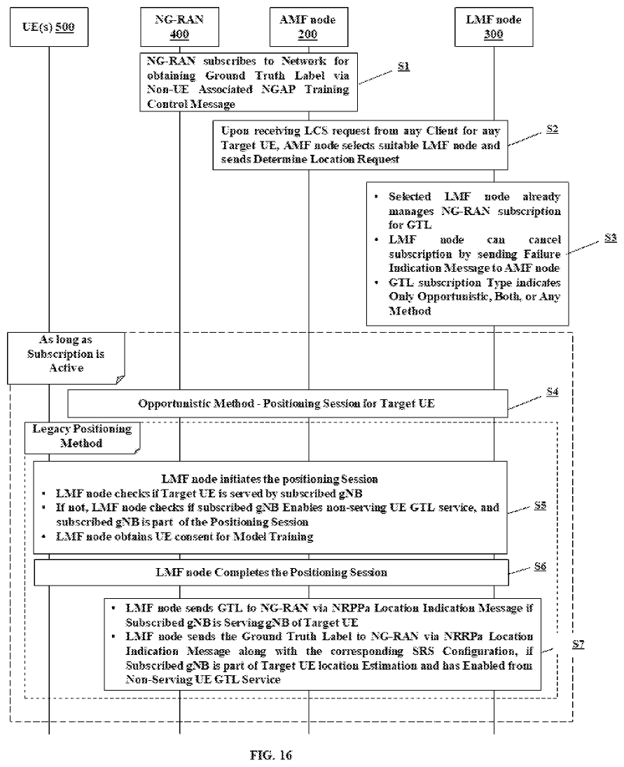

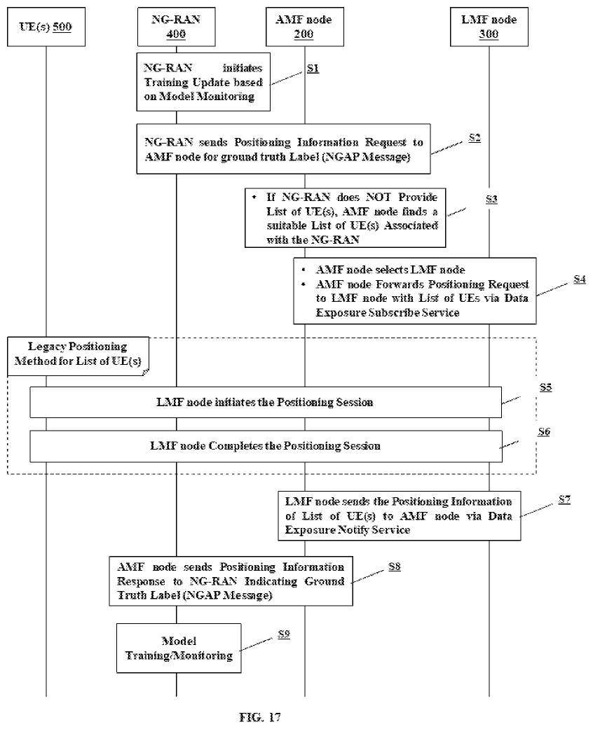

FIG. 15 is a sequence diagram that illustrates a proactive method of LMF-managed NG-RAN subscription for obtaining the ground truth label according to embodiments disclosed herein, and FIG. 16 is a sequence diagram that illustrates an opportunistic method of LMF-managed NG-RAN subscription for obtaining the ground truth label according to embodiments disclosed herein. In an embodiment, FIGS. 15-16 depict the signaling mechanism for the LMF-managed NG-RAN subscription method to get the GTL. Like the previous AMF-managed NG-RAN subscription method, at step S1 the NG-RAN (400) subscribes to the network for obtaining the GTL using a new non-UE associated next generation access protocol (NGAP) message, viz., NGAP model training control message. This message acts as the subscription request from the NG-RAN (400) to the network and is oblivious to the subscription managing entity. This message carries the information related to the GTL requirement such as indication to start/stop the subscription and optional parameters such as the list of UE(s) (500) preferred by the NG-RAN (400) for training indicated using the NG-AP IDs, the subscription period for which the GTL is required, the maximum number of GTL data required, area of interest (AoI) for the NG-RAN (400) to train the AI/ML model, an indication to enable/disable GTL data from non-serving UE(s), etc.

In an embodiment, the AMF node (200) does not take any action on the subscription information except for discovering and selecting one or more LMF nodes (300) based on the tracking area of the subscribed NG-RAN (400) and the load utilization of the LMF node(s) (300). The AMF node (200) uses a data exposure API to forward the NG-RAN (400) subscription to the appropriate LMF node(s) (300) at step S2. If the NG-RAN (400) subscription information includes a list of preferred UE(s) (500), the AMF node (200) obtains the relevant consents for the model training and positioning from the UE(s) (500), translates the corresponding NG-AP ID(s) to the SUPI(s) of the UE(s) (500) that provided consents, and includes the list of UE(s) (500) in the data exposure API to the LMF node(s) (300). The AMF node (200) can segregate the list of UE(s) (500) as per the tracking area and/or the load of the LMF nodes (300) if multiple LMF nodes (300) are selected for managing the subscription.

In an embodiment, at step S3 the LMF node(s) (300) can accept or cancel the subscription request. If the LMF node(s) (300) accept(s) the subscription, the LMF node(s) (300) request(s) a list of the UE(s) (500) if the subscription type indicates only proactive, both, or any method as depicted in FIG. 15. At step S4, if the list is not provided by the NG-RAN (400), the LMF node(s) (300) find(s) a list of UE(s) (500) according to the requirements in the subscription information with the relevant consents for training and positioning with the help of the AMF node (200). At step S4, positioning session for each consent-provided UE in the list is initiated. At step S5, the LMF node(s) (300) initiate(s) the legacy positioning procedures as per the norms for each of the UE(s) (500) in the list, and once the location estimation is completed at step S6, the LMF node(s) (300) send(s) the corresponding UE(s) (500) location to the subscribed NG-RAN (400) using the NRPPa location indication message at step S7. This process continues until the subscription is active or the requirements in the subscription information are met. The subscription can also be cancelled by the LMF node(s) (300) by sending a failure indication message to the AMF node (200), which will be indicated to the NG-RAN (400) by the AMF node (200). The NG-RAN (400) can update the subscription information if required by indicating the update request in the NGAP model training control message to the AMF node (200) with the updated parameters. The NG-RAN (400) can also stop the subscription if it no longer requires the data collection for the AI/ML training and/or performance monitoring by indicating the stop request in the NGAP model training control message to the AMF node (200).

FIG. 16 is a sequence diagram that illustrates an opportunistic method of LMF-managed NG-RAN subscription for obtaining the ground truth label according to embodiments disclosed herein. At step S1 the NG-RAN (400) subscribes to Network for obtaining Ground Truth Label via Non-UE Associated NGAP Training Control Message. At step S2 upon receiving an LCS request from any Client for any Target UE the AMF node (200) selects a suitable LMF node (300) and sends Determine Location Request.

In an embodiment the LMF node (300) can use the opportunistic method by taking advantage of any positioning request invoked by any client for any UE (500) associated with the subscribed NG-RAN (400) if the GTL subscription type indicates only opportunistic both or any methods at step S3 as depicted in FIG. 16. When the LMF node (300) receives a determine location request from the AMF node (200) for a UE (500) connected to the NG-RAN (400) with GTL subscription the LMF node (300) requests the consent of the UE (500) for model training if not already indicated by the AMF node (200) and if the consent is provided the LMF node (300) proceeds with the initiation of the positioning session for the UE (500) at step S4. Once the location estimate is computed the results are sent to the subscribed NG-RAN (400) additionally using the NRPPa location indication message. At step S5, the LMF node (300) initiates the positioning Session by checking if Target UE (510) is served by subscribed gNB. If not, the LMF node (300) checks if subscribed gNB enables non-serving UE GTL service, and subscribed gNB is part of the Positioning Session. The LMF node (300) then obtains UE consent for Model Training. The LMF node (300) completes the Positioning Session at step S6 and sends GTL to NG-RAN via NRPPa Location Indication Message if Subscribed gNB is Serving gNB of Target UE. Further, the LMF node (300) sends the Ground Truth Label to NG-RAN via NRRPa Location Indication Message along with the corresponding SRS Configuration, if Subscribed gNB is part of Target UE location Estimation and has Enabled from Non-Serving UE GTL Service.

In an embodiment, the LMF-managed NG-RAN subscription approach can support obtaining the GTL data of a non-serving UE for the subscribed NG-RAN (400). During any random positioning session initiated by the LMF node (300) for any UE (500), when the LMF node (300) identifies that the NG-RAN (400) with the subscription is an assisting neighboring gNB (330b) for the UE (500) and the subscription information specifies the requirement of the GTL data from the non-serving UE(s), the LMF node (300) proceeds with the initiation of the positioning session for the UE (500), and once the location estimate is computed, the results are sent to the subscribed NG-RAN (400), additionally using the NRPPa location indication message. However, the subscribed NG-RAN (400) cannot identify the non-serving gNB and hence cannot map Part A and Part B information. Therefore, the LMF node (300) also sends the corresponding SRS configuration used by the subscribed gNB during the positioning procedure along with the location information of the non-serving UE as a tag so that the subscribed gNB can use Part A and Part B of the non-serving UE effectively for the model training and/or performance monitoring.

FIG. 17 depicts a sequence diagram illustrating a proactive method for obtaining the GTL from the LMF node according to embodiments disclosed herein. In an embodiment, the proactive method is used to enable data collection from the UE(s) (500) that are not under any ongoing positioning session. Compared to the opportunistic method where the NG-RAN (400) depends on an ongoing positioning session to obtain the data for performing the model training/monitoring, in the proactive method the NG-RAN (400) can trigger the positioning session for a suitable UE (500). This enables the NG-RAN (400) to have better control in performing the model training/monitoring as per the gNB-side model requirements.

In an embodiment, the NG-RAN (400) initiates the training update based on the model monitoring feedback at step S1. At step S2, the NG-RAN (400) sends an NGAP positioning information request message to the AMF node (200). This request indicates the requirement for the ground truth label from the LMF node (300), optionally the list of suitable UE(s), and the measurement type comprising location information, positioning measurements (angle of arrival (AoA), time difference of arrival (TDOA), etc.), and positioning quality of service (QoS) comprising positioning accuracy. If the list of UE(s) is not provided by the NG-RAN (400), the AMF node (200) finds a suitable list of UE(s) associated with the NG-RAN (400) at step S3. At step S4, the AMF node (200) then selects a suitable LMF node (300) and sends a data exposure service request to the LMF node (300) to initiate the positioning session(s) for the list of UE(s). The AMF node (200) indicates to the LMF node (300) that the subscription is for NG-RAN (400) initiated model training. This service request indicates the parameters provided in the NG-RAN (400) positioning information request message.

In an embodiment, for each of the UE(s) (500) in the list, the LMF node (300) obtains the consent for AI/ML model training. For the consent-given UE(s), the LMF node (300) starts the positioning session using a legacy positioning method at step S5. Once the location estimates are computed for the UE(s) (500) at step S6, the LMF node (300) consolidates the information related to the location according to the measurement type provided in the service request. If the measurement type is not provided, the LMF node (300) uses the location estimate by default. At step S7, the LMF node (300) then prepares the positioning information report of all the UE(s) (500) in the list and sends it to the AMF node (200), preferably using a data exposure notify service. At step S8, the AMF node (200) sends an NGAP positioning information response message to the NG-RAN (400) indicating the ground truth labels of the suitable UE(s) (500) with the corresponding NGAP identities. The NG-RAN (400) uses the ground truth label information for data collection from the corresponding UE(s), if not already taken, to perform the model training/monitoring at step S9.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

We claim:

1. A method for handling a next-generation radio access network (NG-RAN (400)) subscription to Core Network for obtaining a Ground Truth Label (GTL) for AI/ML-based positioning, comprising:
receiving, by an access and mobility management function (AMF) node (200), a subscription request from a NG-RAN (400) for obtaining the GTL, wherein the subscription request message comprises a GTL subscription type;
deciding, by the AMF node (200), to perform one of accept, deny, and cancel, the subscription request;
determining and performing, by the AMF node (200), at least one of the proactive method and the opportunistic method to obtain the GTL for the AI/ML-based positioning from at least one location management function (LMF) node (300), when the subscription request is accepted, wherein the at least one of the proactive method and the opportunistic method is indicated in the GTL subscription type; and
reporting, by the AMF node (200), a failure message to the RAN when the subscription request is one of denied and cancelled.

2. The method as claimed in claim 1, wherein the at least one LMF node (300) is selected based on at least one of a tracking area of the subscribed RAN and a load utilization.

3. The method as claimed in claim 1, wherein performing, by the AMF node (200), the proactive method comprises:
preparing, by the AMF node (200), at least one UE (500) for model training and positioning;
obtaining, by the AMF node (200), consents for model training and positioning of the at least one UE (500);
sending, by the AMF node (200), a determine location request message to the at least one LMF node (300), wherein the determine location request message comprises an instruction indicated by a share location parameter set as ‘NG-RAN (400) only’.

4. The method as claimed in claim 3, wherein the instruction sends the GTL to the subscribed NG-RAN (400) identified at the LMF node (300) by a NG-RAN (400) Identifier (ID).

5. The method as claimed in claim 3, wherein the at least one UE (500) is one of obtained from the NG-RAN (400) and selected by the AMF node (200).

6. The method as claimed in claim 3, preparing, by the AMF node (200), at least one UE (500) for model training and positioning, comprising:
receiving, by the AMF node (200), a NGAP positioning information request message from the NG-RAN (400), wherein the NG-RAN (400) initiates the training update based on the model monitoring feedback;
sending, by the AMF node (200), a data exposure service request to the LMF node (300) to initiate the positioning session(s) for the at least one UE (500), after selecting a suitable LMF node (300);
indicating, by the AMF node (200), to the LMF node (300) that the subscription is for NG-RAN initiated model training;
receiving, by the AMF node (200), a positioning information report of at least one UE (500) from the LMF node (300) using a data exposure notify service; and
sending, by the AMF node (200), a NGAP positioning information response message to the NG-RAN (400) indicating the GTLs of the at least one UE (500) with the corresponding NGAP identities.

7. The method as claimed in claim 6, wherein the NGAP positioning information request message comprises at least one of the measurement type comprising location information, positioning measurements, positioning quality of service (QoS).

8. The method as claimed in claim 6, wherein the data exposure service request indicates the parameters provided in the NG-RAN (400) positioning information request message.

9. The method as claimed in claim 1, wherein performing, by the AMF node (200), the opportunistic method comprises:
receiving, by the AMF node (200), a Location Services (LCS) request for the at least one UE (500) from an external client;
identifying, by the AMF node (200), at least one UE (500) associated with the NG-RAN (400);
obtaining, by the AMF node (200), consents for model training and positioning of the at least one UE (500); and
sending, by the AMF node (200), a determine location request message to the at least one LMF node (300), wherein the determine location request message comprises an instruction indicated by a share location parameter set as ‘NG-RAN (400) also’.

10. The method as claimed in claim 9, wherein the instruction sends the GTL to the NG-RAN (400) identified at the LMF node (300) by a NG-RAN (400) Identifier (ID).

11. The method as claimed in claim 1, wherein the subscription request comprising a NGAP model training control message is a non-UE associated Next Generation Application Protocol (NG-AP) message.

12. The method as claimed in claim 11, wherein the non-UE associated NG-AP message comprises information related to GTL requirement, wherein the GTL requirement comprises at least one of an optional parameters and an indication to at least one of start, update and stop the subscription, wherein the optional parameters comprise at least one of the at least one UE (500) preferred by the RAN for training indicated using the NG-AP IDs, a subscription period, a maximum number of GTL data required, an area of interest (Ao) and an indication to one of enable and disable the GTL data from non-serving UEs.

13. A method for handling a next-generation radio access network (NG-RAN (400)) subscription to Core Network for obtaining a Ground Truth Label (GTL) for AI/ML-based positioning, comprising:
receiving, by at least one location management function (LMF) node (300), a determine location request message for obtaining the GTL, wherein the determine location request message comprises an instruction indicated by a share location parameter set as one of ‘NG-RAN (400) also’ and ‘NG-RAN (400) only’;
initiating, by the at least one LMF node (300), positioning procedures for estimating the location of at least one UE (500); and
sending, by the at least one LMF node (300), the GTL of the at least one UE (500) to the NG-RAN (400) using location indication message, wherein the NG-RAN (400) is identified at the LMF node (300) by a NG-RAN (400) Identifier (ID).

14. The method as claimed in claim 13, wherein the location indication message is send using one of a new radio positioning protocol annex (NRPPa) and LTE positioning protocol (LPPa).

15. The method as claimed in claim 13, wherein the GTL is at least one of location of at least one UE (500), a gNB ID, a LoS/NLoS information, a time stamp, a quality information and gNB Rx-Tx time difference.

16. The method as claimed in claim 13, wherein sending the GTL of the at least one UE (500) is performed until one of the subscription is active and the requirements in subscription information are met.

17. The method as claimed in claim 13, wherein initiating, by the at least one LMF node (300), positioning procedures for estimating the location of at least one UE (500), comprises:
obtaining, by the LMF node (300), consent for AI/ML model training for at least one UE (500); and
consolidating, by the LMF node (300), the information related to the location according to the measurement type provided in the service request after the location estimates are computed for the at least one UE (500).

18. The method as claimed in claim 17, wherein the LMF node (300) utilizes a location estimate by default, when the measurement type is not provided.

19. The method as claimed in claim 17, wherein the measurement type comprises at least one of location information, positioning measurements, positioning quality of service (QoS).

20. An access and mobility management function (AMF) node (200) for handling a next-generation radio access network (NG-RAN (400)) subscription to Core Network for obtaining a Ground Truth Label (GTL) for AI/ML-based positioning, comprising:
a processor (201);
a memory (202); and
a GTL subscription controller (204), connected to the processor (201) and the memory (202), wherein the GTL subscription controller (204):
receives a subscription request from a NG-RAN (400) for obtaining the GTL, wherein the subscription request message comprises a GTL subscription type;
decides to perform one of accept, deny, and cancel, the subscription request;
determines and performs at least one of the proactive method and the opportunistic method to obtain the GTL for the AI/ML-based positioning from at least one location management function (LMF) node (300), when the subscription request is accepted, wherein the at least one of the proactive method and the opportunistic method is indicated in the GTL subscription type; and
reports a failure message to the RAN when the subscription request is one of denied and cancelled.

21. A location management function (LMF) node (300) for handling a next-generation radio access network (NG-RAN (400)) subscription to Core Network for obtaining a Ground Truth Label (GTL) for AI/ML-based positioning, comprising:
a processor (301);
a memory (302); and
a positioning session controller (304), connected to the processor (301) and the memory (302), wherein the positioning session controller (304):
receives a determine location request message for obtaining the GTL, wherein the determine location request message comprises an instruction indicated by a share location parameter set as one of ‘NG-RAN (400) also’ and ‘NG-RAN (400) only’;
initiates positioning procedures for estimating the location of at least one UE (500); and
sends the GTL of the at least one UE (500) to the NG-RAN (400) using location indication message, wherein the NG-RAN (400) is identified at the LMF node (300) by a NG-RAN (400) Identifier (ID).

22. A method for handling a next-generation radio access network (NG-RAN (400)) subscription to Core Network for obtaining a Ground Truth Label (GTL) for AI/ML-based positioning, comprising:
receiving, by an access and mobility management function (AMF) node (200), a subscription request from a NG-RAN (400) for obtaining ground truth label (GTL), wherein the subscription request message comprises a GTL subscription type;
performing, by the AMF node (200), one of:
sending the subscription of the NG-RAN (400) to at least one of LMF node (300) using a data exposure application programming interface (API); and
sending the subscription of the NG-RAN (400) to the at least one LMF node (300) and a determine location request for a UE (500) connected to the NG-RAN (400);
receiving, by the AMF node (200) from the at least one LMF node (300), a notification related to the subscription request indicating one of accepted, denied, and cancelled; and
transmitting, by the AMF node (200), a failure indication message to the NG-RAN (400) if the notification is one of denied or cancelled.

23. The method as claimed in claim 22, wherein the determine location request is sent after receiving LCS request from a client for the UE (500).

24. The method as claimed in claim 22, wherein the at least one of LMF node (300) is selected based on at least one of the tracking area of the NG-RAN (400) and the load utilization.

25. The method as claimed in claim 22, wherein the subscription request comprising a NGAP model training control message is a non-UE associated Next Generation Application Protocol (NGAP) message.

26. The method as claimed in claim 22, wherein the non-UE associated NG-AP message comprises the information related to GTL requirement,
wherein the GTL requirement comprises at least one of an optional parameters and an indication to at least one of start and stop the subscription,
wherein the optional parameters comprise at least one of at least one UE (500) preferred by the NG-RAN (400) for training indicated using the NG-AP IDs, a subscription period for which the GTL is required, a maximum number of GTL data required, an area of interest (AoI) for the NG-RAN (400) to train the AI/ML model and an indication to enable or disable the GTL data from non-serving UEs.

27. The method as claimed in claim 26, comprising:
obtaining, by the AMF node (200), a consent for the model training and positioning for the at least one UE (500);
translating, by the AMF node (200), the corresponding NG-AP IDs to the subscriber permanent identifiers (SUPIs) of the at least one UE (500) that provided consent; and
including, by the AMF node (200), at least one UE (500) from the post-consent set of UEs (500) in the data exposure API to the LMF node (300).

28. The method as claimed in claim 22, comprising:
associating, by the AMF node (200), the at least one UE (500) with the at least one LMF node (300) based on the at least one of tracking area and the load utilization.

29. A method for handling a next-generation radio access network (NG-RAN (400)) subscription to Core Network for obtaining a ground truth label (GTL) for AI/ML-based positioning, comprising:
receiving, by the at least one location management function (LMF) node (300), a subscription request of the NG-RAN (400) from the AMF node (200) for the ground truth label (GTL);
deciding, by the at least one LMF node (300), to perform one of accept, deny and cancel the subscription request;
sending, by the at least one LMF node (300), a notification related to the subscription request indicating one of accepted, denied, and cancelled;
performing, by the at least one LMF node (300), at least one of the proactive method and the opportunistic method to send the GTL for the AI/ML-based positioning to the AMF node (200) when the subscription request is accepted.

30. The method as claimed in claim 29, wherein the subscription request of the NG-RAN (400) is received using at least one of the data exposure application programming interface (API) or determine location request.

31. The method as claimed in claim 29, wherein performing, by the LMF node (300), the proactive method, comprising:
performing, one of:
requesting, by the at least one LMF node (300), at least one UE (500) from the AMF node (200) with consent for model training and positioning; and
providing the at least one UE (500) to the AMF node (200), when the subscription is accepted;
obtaining, by the at least one LMF node (300), at least one UE (500) with consent for model training and positioning in the area of interest;
initiating, by the at least one LMF node (300), positioning procedures towards at least one UE (500);
sending, by the at least one LMF node (300), the GTL to the NG-RAN (400) using a location indication message.

32. The method as claimed in claim 31, wherein the location indication message is sent using one of a new radio positioning protocol annex (NRPPa) and LTE positioning protocol annex (LPPa).

33. The method as claimed in claim 31, wherein the GTL is at least one of location of at least one UE (500), a gNB ID, a LoS/NLoS information, a time stamp, a quality information and gNB Rx-Tx time difference.

34. The method as claimed in claim 31, wherein the LMF node (300) finds the at least one UE (500) according to the requirements in the subscription information with the relevant consents for training and positioning using the AMF node (200), when the at least one UE (500) is not provided by the NG-RAN (400).

35. The method as claimed in claim 29, wherein performing, by the LMF node (300), the opportunistic method, comprising:
receiving, by the at least one LMF node (300), a determine location request from the AMF node (200) for at least one UE (500) connected to the RAN with the GTL subscription;
requesting, by the at least one LMF node (300), consents of the at least one UE (500) for model training and positioning, if not already indicated by the AMF node (200);
initiating, by the at least one LMF node (300), positioning procedures towards the at least one UE (500);
sending, by the at least one LMF node (300), the GTL to the NG-RAN (400) using location indication message.

36. The method as claimed in claim 35, wherein the location indication message is sent using one of a new radio positioning protocol annex (NRPPa) and LTE positioning protocol annex (LPPa).

37. The method as claimed in claim 35, wherein the GTL is at least one of location of at least one UE (500), a gNB ID, a LoS/NLoS information, a time stamp, a quality information and gNB Rx-Tx time difference.

38. The method as claimed in claim 29, wherein the at least one LMF node (300) continues to send the GTL of the at least one UE (500) to the subscribed RAN until the subscription is active or the requirements in the subscription information are met.

39. An access and mobility management function (AMF) node (200) for handling a next-generation radio access network (NG-RAN (400)) subscription to Core Network for obtaining a Ground Truth Label (GTL) for AI/ML-based positioning, comprising:
a processor (201);
a memory (202); and
a GTL subscription controller (204), connected to the processor (201) and the memory (202), wherein the GTL subscription controller (204):
receives a subscription request from a NG-RAN (400) for obtaining ground truth label (GTL), wherein the subscription request message comprises a GTL subscription type;
performs one of:
sending the subscription of the NG-RAN (400) to at least one of LMF node (300) using a data exposure application programming interface (API); and
sending the subscription of the NG-RAN (400) to the at least one LMF node (300) and a determine location request for a UE (500) connected to the NG-RAN (400);
receives from the at least one LMF node (300), a notification related to the subscription request indicating one of accepted, denied, and cancelled; and
transmits a failure indication message to the NG-RAN (400) if the notification is one of denied or cancelled.

40. A location management function (LMF) node (300) for handling a next-generation radio access network (NG-RAN (400)) subscription to Core Network for obtaining a Ground Truth Label (GTL) for AI/ML-based positioning, comprising:
a processor (301);
a memory (302); and
a positioning session controller (304), connected to the processor (301) and the memory (302), wherein the positioning session controller (304):
receives a subscription request of the NG-RAN (400) from the AMF node (200) for the ground truth label (GTL);
decides to perform one of accept, deny and cancel the subscription request;
sends a notification related to the subscription request indicating one of accepted, denied, and cancelled; and
performs at least one of the proactive method and the opportunistic method to send the GTL for the AI/ML-based positioning to the AMF node (200) when the subscription request is accepted.
